(19) United States
(12) Patent Application Publication
(10) Pub. No.: US 2005/0270304 A1
(43) Pub. Date: Dec. 8, 2005

(54) Display controller, electronic apparatus and method for supplying image data

(76) Inventor: Atsushi Obinata, Tokyo (JP)

Correspondence Address: HARNESS, DICKEY & PIERCE, P.L.C., P.O. BOX 828, BLOOMFIELD HILLS, MI, 48303, US

(21) Appl. No.: 11/138,035

(22) Filed: May 26, 2005

(30) Foreign Application Priority Data
Jun. 2, 2004 (JP) 2004-164663

(51) Int. Cl. G09G 5/02

(52) U.S. Cl. 345/604

(57) ABSTRACT

A display controller includes a memory in which image data as a YUV format and image data as a RGB format are mixedly stored, a format conversion part 30 that performs a conversion processing between the YUV format and the RGB format, an image data input interface that supplies input image data as the YUV format to the memory, and a display driver interface that outputs image data as the RGB format read from the memory to the display driver. The format conversion part converts image data as the YUV format retrieved from the memory to the RGB format so as to write it in the memory, and supplies the image data as the RGB format to the display driver.

### RELATED APPLICATIONS

This application claims priority to Japanese Patent Application No. 2004-164663 filed Jun. 2, 2004 which is hereby expressly incorporated by reference herein in its entirety.

### BACKGROUND

1. Technical Field

The present invention relates to a display controller, an electronic apparatus, and a method for supplying image data.

2. Related Art

In recent years, display panels typified by liquid crystal display (LCD) panels are often mounted to mobile apparatuses (electronic apparatuses in a broad sense) such as cellular phones, etc. The display panels are driven by display drivers based on image data. The image data is, for example, retrieved by camera modules, or is generated or processed by a host. The display drivers receive such image data and display sync signals to perform driving controls of the display panels. The display controllers can perform supplying such image data and display sync signals instead of the host so as to reduce processing loads of the host.

Image data are defined by several formats. Among them, the YUV format and the RGB format are often used.

The YUV format, by utilizing characteristics of human's eyes, can reduce the data size of image data smaller than that of the RGB format, while enabling compression algorithms such as a joint photographic experts group (JPEG), a moving picture experts group (MPEG), etc., to be efficient. For example, image data from camera modules is the YUV format.

Alternatively, the RGB format is suitable for image data for LCD panel display because it has the image data in each pixel. In addition, the image data is easily processed in each pixel. This also makes it suitable for image processing such as three-dimensional image processing, etc., performed by the host, etc. For example, image data that is input and output relative to the host, and image data that is output to the display drivers are in the RGB format.

Therefore, image data as the YUV format and image data as the RGB format are input and output to the display controller provided instead of the host. Consequently, the display controller converts the format of the image data in accordance with the output of the input image data. The format of image data stored in a video memory provided inside or outside of the display controller is, for example, unified in the YUV format.

However, if the image data stored in the video memory, which is provided inside or outside the display controller, is unified as the YUV format, the data is required to be converted to the RGB format to supply it to the host that performs three-dimensional image processing or graphic modules.

Alternatively, if the image data stored in the memory is unified as the RGB format, the data size becomes larger than that of the YUV format. For example, the RGB 8:8:8 format needs 24 bits per pixel. However, in the YUV 4:2:2 format that has the same image quality as that of the RGB 8:8:8 format, 16 bits are enough per pixel. Therefore, the RGB 8:8:8 format has a disadvantage in that the number of pixels to be memorized is reduced if a memory capacity is small.

Also, if it is mounted in mobile apparatuses, low power consumption is required. Thus, the display controller preferably includes the video memory.

Taking the above-mentioned technical problems into account, the present invention aims to provide a display controller that satisfies both memory efficiency and processability of image data, an electronic apparatus, and a method for supplying image data.

### SUMMARY

In order to solve the above-mentioned problems, a display controller that supplies image data to a display driver driving a display panel according to a first aspect of the present invention includes a memory in which image data as the YUV format and image data as the RGB format are mixedly stored, a format conversion part that performs a conversion processing between the image data as the YUV format and the image data as the RGB format, an image data input interface part to which the image data as the YUV format is input and supplies the image data to the memory, and a display driver interface that outputs the image data as the RGB format read from the memory to the display driver. The format conversion part reads the image data as the YUV format so as to convert the image data to the RGB format, and then writes the converted image data as the RGB format in the memory. The image data as the RGB format that is written in the memory by the format conversion part is supplied to the display driver.

In the first aspect of the invention, the image data as the YUV format that is input via the image data input interface is stored in the memory without any changes. Then, the format conversion part reads the image data from the memory so as to convert the image data as the YUV format to the image data as the RGB format, writing back the image data as the RGB format in the memory again. According to the first aspect of the invention, the image data as the YUV format and the image data as the RGB format are mixedly stored in the memory. The format conversion part accesses the memory so as to perform a format conversion, writing back the image data after format conversion in the memory.

This allows a host to reduce its processing loads caused by the format conversion.

In addition, the image data as the YUV format input from the image data input interface is written in the memory without converting the image data to the RGB format. This allows the memory to increase its efficiency of use as compared with a case where the image data stored in the memory is unified in the RGB format.

Further, image data can be retained in the memory as a format suitable for the display driver to display. As compared with a case where the image data stored in the memory is unified as the YUV format, converting the YUV format to the RGB format is not required every time, even though in a case where the same image data is repeatedly output to the display driver.

In the display controller according to the first aspect of the invention, the format conversion part can set a first write start address of the converted image data as the RGB format in the memory so that a memory region in the memory is provided in which the image data as the YUV format before conversion is stored, while the converted image data as the RGB format is written so as to overlapped. Then, while updating a write address based on the first write start address, the image data as the RGB format can be written in the memory region in the memory specified by the write address.

In the display controller according to the first aspect of the invention, in a case where a memory region of the image data as the YUV format before conversion is designated by a first start address and a first end address, the first write start address may be smaller than the address obtained by subtracting an address corresponding to a data size of the converted image data as the RGB format from the first end address.

According to the first aspect of the invention, the converted image data as the RGB format can be written back in the memory region of the image data as the YUV format before conversion, thereby enabling a memory capacity required as an operation region for format conversion processing to be reduced correspondingly.

In the display controller according to the first aspect of the invention, a host interface is included to which the image data as the YUV format or the image data as the RGB format is input from a host so as to supply the image data to the memory, while by which the image data as the YUV format or the image data as the RGB format that are read from the memory is output to the host. The format conversion part can read the image data as the RGB format so as to convert the image data to the YUV format, write the converted image data as the YUV format to the memory. The image data as the YUV format that is written in the memory by the format conversion part is output.

According to the first aspect of the invention, in addition to the above-mentioned effects, image data can be output to a host, etc., with ease of three-dimensional image processing, etc. Thus, processability of image data stored in the memory can be maintained as compared with a case in which the image data stored in the memory is unified in the YUV format.

In the display controller according to the first aspect of the invention, the format conversion part can set a second write start address of the converted image data as the YUV format in the memory so that a memory region in the memory is provided in which the image data as the RGB format before conversion is stored, while the converted image data as the YUV format is written so as to be overlapped. Then, while updating a write address based on the second write start address, the image data as the YUV format can be written in the memory region in the memory specified by the write address.

In the display controller according to the first aspect of the invention, in a case where a memory region of the image data as the RGB format before conversion is designated by a second start address and a second end address in the memory, the second write start address may be the second start address or smaller than the second start address.

According to the first aspect of the invention, the converted image data as the YUV format can be written back in the memory region of the image data as the RGB format before conversion, thereby enabling a memory capacity required as an operation region for format conversion processing to be reduced correspondingly.

In the display controller according to the first aspect of the invention, the format conversion part includes a first and a second format conversion parts each of which performs a format conversion processing and a write processing of the converted image data to the memory individually. The first format conversion part can read the image data as the YUV format from the memory so as to convert the image data to the RGB format, in turn write the converted image data as the RGB format in the memory. The second format conversion part can read the image data as the RGB format from the memory so as to convert the image data to the YUV format, in turn, write the converted image data as the YUV format in the memory.

According to the first aspect of the invention, a plurality of format conversion processings can be performed simultaneously as exemplified as follows: if the first format conversion part converts the image data as the YUV format to the image data as the RGB format, the second format conversion part can convert another image data as the RGB format to the image data as the YUV format.

An electronic apparatus according to a second aspect of the invention includes a display panel, the display controller described in any of the above, and a display driver that drives the display panel based on image data supplied by the display controller.

In addition, in the electronic apparatus according to the second aspect of the invention, a host can be included that inputs and outputs the image data as the RGB format or the image data as the YUV format relative to the display controller.

According to the second aspect of the invention, an electronic apparatus can be provided that includes a display controller equipped with a memory that can satisfy efficiency of the memory as well as processability of image data, the display controller reducing processing loads.

A method for supplying image data in order to supply image data to a display driver driving a display panel includes a step of mixedly storing image data as a YUV format and image data as a RGB format in a memory, a step of reading the image data as the YUV format from the memory so as to convert the image data to the RGB format, a step of writing the converted image data as the RGB format in the memory, and a step of supplying the image data as the RGB format written in the memory to the display driver.

In the method for supplying image data according to the third aspect of the invention, the image data as the RGB format can be read from the memory so as to convert the image data to the YUV format, in turn the converted image data as the YUV format can be written in the memory. The image data as the YUV format written in the memory can be supplied to a host.

### BRIEF DESCRIPTION OF THE DRAWINGS

FIG. 1 is a block diagram illustrating a rough configuration of a display controller according to an embodiment of the present invention.

FIG. 2 is a block diagram illustrating a rough configuration of a display controller in the first comparative example according to the embodiment of the invention.

FIG. 3 is a block diagram illustrating a rough configuration of a display controller in the second comparative example according to the embodiment of the invention.

FIG. 4 is an explanatory diagram of a RGB format and a YUV format.

FIG. 5 is an explanatory diagram illustrating a setting method of the write start address in a case where the YUV format is converted to the RGB format.

FIG. 6 is an explanatory diagram illustrating a setting method of the write start address in a case where the RGB format is converted to the YUV format.

FIG. 7 is a block diagram illustrating a detailed configuration example of a display controller according to the embodiment of the invention.

FIG. 8 is a block diagram illustrating a configuration example of the YUV-RGB conversion circuit in FIG. 7.

FIG. 9 is a timing chart illustrating an operational example of the YUV-RGB conversion circuit in FIG. 8.

FIG. 10 is an explanatory diagram illustrating a conversion formula of a YUV 4:4:4-RGB 8:8:8 conversion part.

FIG. 11 is a block diagram illustrating a hardware configuration example of the YUV 4:4:4-RGB 8:8:8 conversion part in FIG. 8.

FIG. 12 is an explanatory diagram illustrating shift adding operation in the YUV 4:4:4-RGB 8:8:8 conversion part in FIG. 11.

FIG. 13 is a timing diagram illustrating an operational example of the YUV 4:4:4-RGB 8:8:8 conversion part in FIG. 11.

FIG. 14 is an explanatory diagram illustrating the conversion formula of RGB 8:8:8-YUV 4:4:4 conversion part in FIG. 8.

FIG. 15 is a flow chart illustrating a processing example of a YUV-RGB conversion circuit.

FIG. 16 is a flow chart illustrating a processing example of a host according to the embodiment of the invention.

FIG. 17 is a block diagram illustrating a rough configuration of a display controller in the first modification example according to the embodiment of the invention.

FIG. 18 is a block diagram illustrating a rough configuration of a display controller in the second modification example according to the embodiment of the invention.

FIG. 19 is a block diagram illustrating a configuration example of electronic apparatuses according to the embodiment of the invention.

### DETAILED DESCRIPTION

An embodiment according to the present invention will be described below with reference to the drawings. The embodiment described below is not intended to unreasonably limit the present invention set forth in the claims. Also, the present invention may be practiced without some of the specific elements described below.

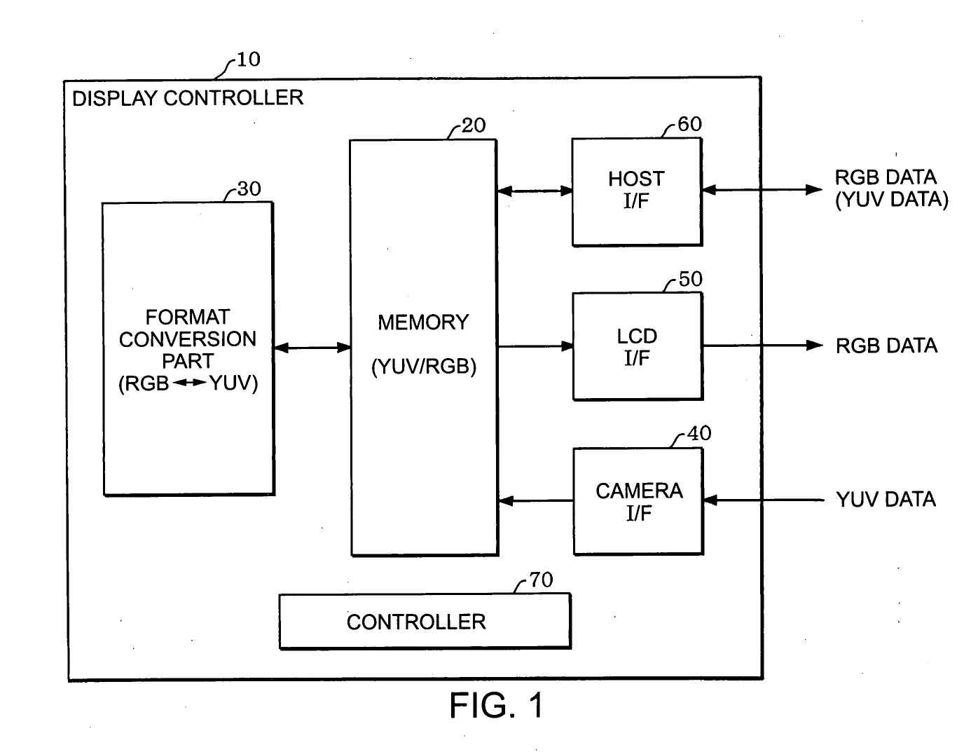

FIG. 1 is a block diagram illustrating an outline of configuration of a display controller according to the embodiment of the present invention.

A display controller 10 is provided between a host and a display driver that are not shown. The display controller 10 supplies image data to the display driver that drives a display panel.

The display controller 10 includes a memory 20 that functions as a video memory and a format conversion part 30 that performs a format conversion of image data stored in the memory 20.

Image data as a YUV format and image data as a RGB format are mixedly stored in the memory 20. That is, image data as the YUV format or the RGB format that is input to the display controller 10 is temporarily stored in the memory 20 as the same format of the input image data without converting formats.

The format conversion part 30 performs a conversion processing between image data as the YUV format and image data as the RGB format. More specifically, the format conversion part 30 converts image data as the YUV format read from the memory 20 to image data as the RGB format. In addition, the format conversion part 30 converts image data as the RGB format read from the memory 20 to image data as the YUV format. The format conversion part 30 performs the conversion processing to image data stored in the memory 20 in this way so as to write the converted image data as the memory 20 again.

The display controller 10, then, supplies the image data as the RGB format written in the memory 20 by the format conversion part 30 to the display driver.

The display controller 10 includes a camera interface (I/F) circuit 40 (image data input interface in a broad sense), and a LCD interface (I/F) circuit 50 (display driver interface in a broad sense).

Image data as the YUV format (YUV data) is input to the camera I/F circuit 40 from a camera module (not shown) as an imaging part. The camera I/F circuit 40 performs an interface processing of the image data, and supplies the image data that has been subjected to the interface processing to the memory 20, the data being written in the memory 20. The interface processing includes a receiving processing, and a signal buffering relative to the camera module.

The LCD I/F circuit 50 outputs image data as the RGB format (RGB data) read from the memory 20 to a display driver that is not shown. The LCD I/F circuit 50 performs an interface processing of image data so as to output the image data that has been subjected to the interface processing to the display driver. The interface processing includes a transmitting processing, and a signal buffering relative to the display driver.

The display controller 10 also includes a host interface circuit 60 (host interface in a broad sense). Image data as the RGB format (RGB data) is input to the host I/F circuit 60 from a host (not shown) that generates image data or processes image data such as three-dimensional image data processing,. etc. In this case, the camera I/F circuit 60 performs an interface processing so as to supply the image data that has been subjected to the interface processing to the memory 20, the data being written in the memory 20. The interface processing includes a receiving processing, and a signal buffering relative to the host. Also, the image data as the RGB format read from the memory 20 is input to the host I/F circuit 60. The host I/F circuit 60 performs an interface processing so as to output the image data that has been subjected to the interface processing to the host. The interface processing includes a transmitting processing, and a signal buffering relative to the host.

In this way, the display controller 10 receives the image data as the YUV format via the camera I/F circuit 40 and outputs the image data as the RGB format via the LCD I/F circuit 50. In the memory 20, the image data as the YUV format and the image data as the RGB format are mixedly stored. Thus, the format conversion part 30 accesses the memory 20 for converting formats so as to write back the converted image data as the memory 20. The host can perform the conversion processing between the YUV format and the RGB format. Thus, not only the image data as the RGB format but also the image data as the YUV format may be input and output between the display controller 10 and the host.

In the display controller 10, the format conversion part 30 may be driven either at a time when image data is written in the memory 20 or by an instruction from the host. The display controller 10 includes a controller 70 that controls the above-mentioned operations.

Here, the embodiment of the invention will be described by contrast with comparative examples of the embodiment.

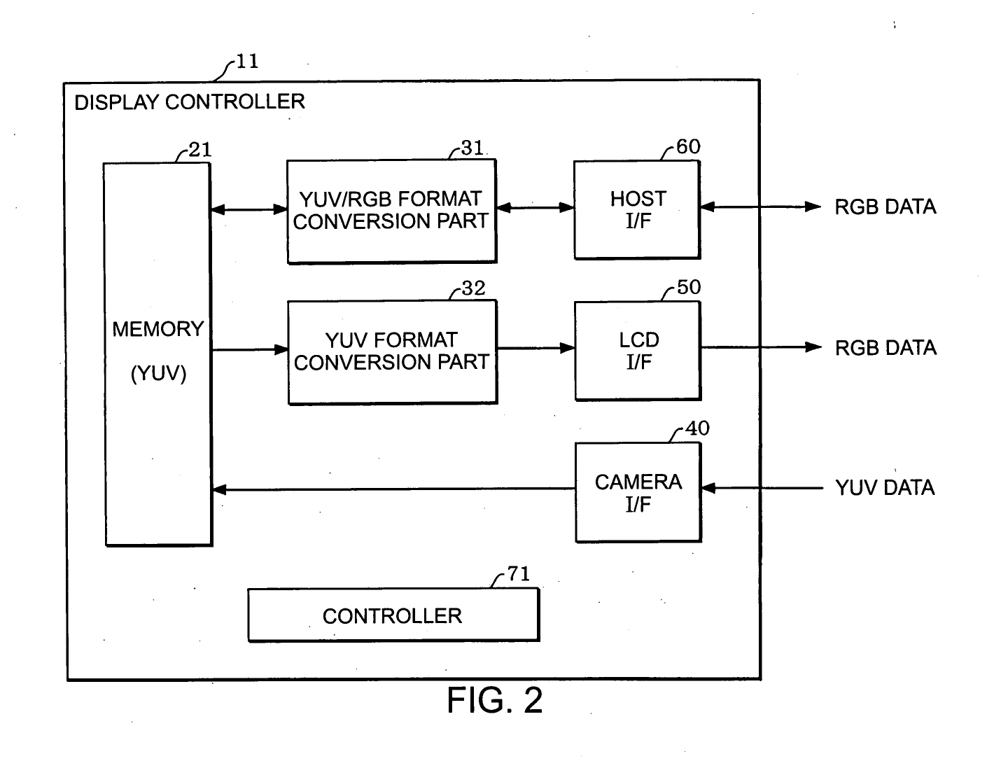

FIG. 2 is a block diagram illustrating a rough configuration of a display controller in the first comparative example of the embodiment of the invention. The same parts as those of FIG. 1 are given the same numerals and the explanation thereof will appropriately be omitted.

A display controller 11 in the first comparative example includes a memory 21, a YUV/RGB format conversion part 31, a YUV format conversion part 32, the camera I/F circuit 40, the LCD I/F circuit 50, the host I/F circuit 60, and a controller 71. In the first comparative example, all the image data stored in the memory 21 is unified in the YUV format.

Therefore, the YUV/RGB format conversion part 31 is provided between the host I/F circuit 60 and the memory 21. The YUV/RGB format conversion part 31 converts the image data as the RGB format from the host to the image data as the YUV format so as to write the converted image data as the memory 21. The YUV/RGB format conversion part 31 also converts the image data as the YUV format from the memory 21 to the image data as the RGB format so as to supply the converted image data to the host I/F circuit 60.

The YUV format conversion part 32 is provided between the LCD I/F circuit 50 and the memory 21. The YUV format conversion part 32 converts the image data as the YUV format from the memory 21 to the image data as the RGB format so as to supply the converted image data to the LCD I/F circuit 50.

The controller 71 controls the display controller 11 that performs the above-mentioned conversions.

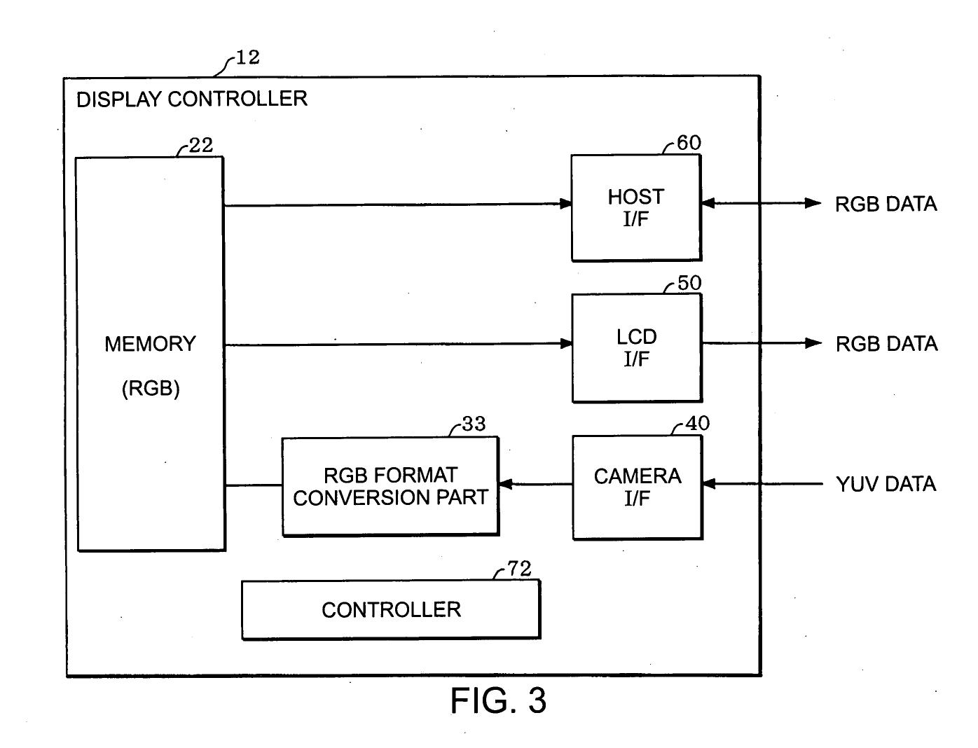

FIG. 3 is a block diagram illustrating a rough configuration of a display controller in the second comparative example of the embodiment of the invention. The same parts as those of FIG. 1 are given the same numerals and the explanation thereof will appropriately be omitted.

A display controller 12 in the second comparative example includes a memory 22, a RGB format conversion part 33, the camera I/F circuit 40, the LCD I/F circuit 50, the host I/F circuit 60, and a controller 72. In the second comparative example, all the image data stored in the memory 22 is unified in the RGB format.

Therefore, the RGB format conversion part 33 is provided between the host I/F circuit 40 and the memory 22. The RGB format conversion part 33 converts the image data as the YUV format from the camera module to the image data as the RGB format so as to write the converted image data as the memory 22.

The controller 72 controls the display controller 12 that performs the above-mentioned conversions.

Next, prior to contrast with the embodiment of the invention and the first and second comparative examples, a format of image data will be described.

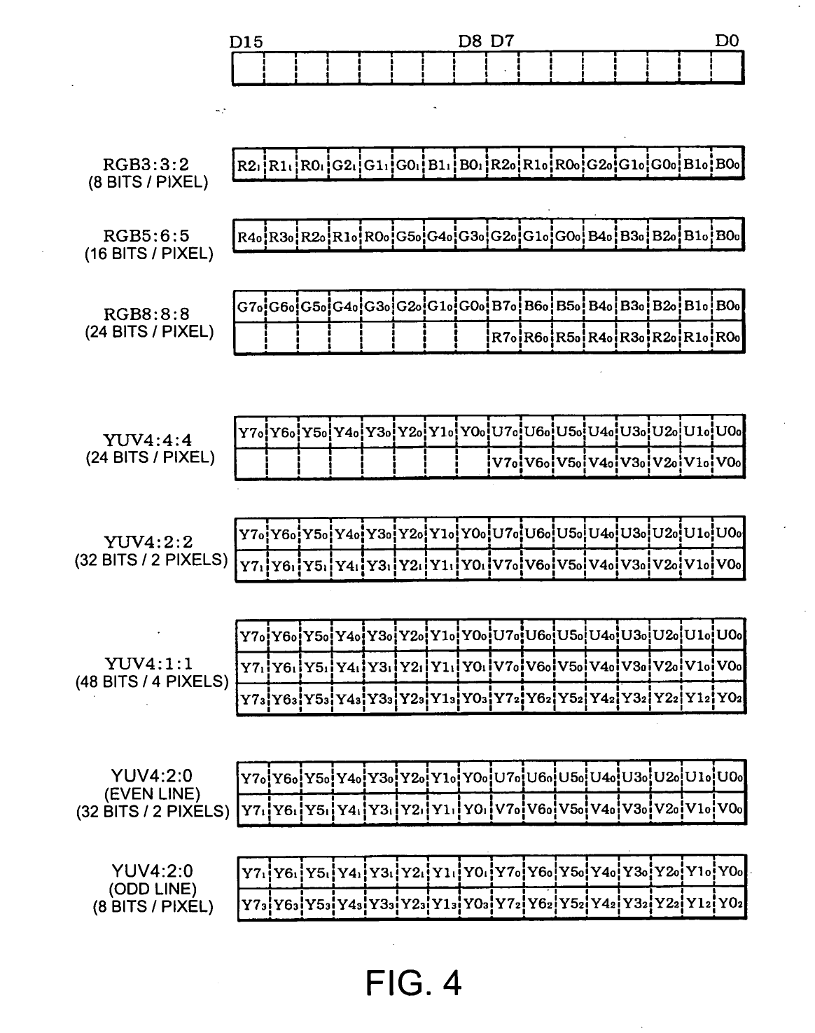

FIG. 4 shows an explanatory diagram of formats of image data.

A RGB format handles data groups as one unit. The data groups are provided to each color component of RGB composing one pixel. Examples of the RGB format include a RGB 3:3:2 format, a RGB 5:6:5 format, a RGB 8:8:8 format, etc.

Image data as the RGB 3:3:2 format is composed of eight bits per pixel. That is, each pixel is represented by a component R of three bits, a component G of three bits, and a component B of two bits. Image data as the RGB 5:6:5 format is composed of 16 bits per pixel. That is, each pixel is represented by a component R of five bits, a component G of six bits, and a component B of five bits. Image data as the RGB 8:8:8 format is composed of 24 bits per pixel. That is, each pixel is represented by a component R of eight bits, a component G of eight bits, and a component B of eight bits.

In the RGB format, the number of bits per pixel is more increasing, the number of colors representing a pixel is also more increasing. The RGB 8:8:8 format handles three bytes as one unit. This makes it difficult to handle the image data as the RGB 8:8:8 format for software or hardware. Thus, it is often handled with four bytes by adding one byte as a dummy. Accordingly, a data size of image data is further increased.

The YUV format handles data groups as one unit. The data groups include a luminance component and two color-difference components in different type provided to one pixel or a plurality of pixels. Examples of the YUV format include a YUV 4:4:4 format, a YUV 4:2:2 format, a YUV 4:4:1 format, etc.

Image data as the YUV 4:4:4 format is composed of 24 bits per pixel. That is, each pixel is represented by a component Y of eight bits, a color-difference component U of eight bits, and a color-difference component V of eight bits. Image quality represented by the image data as the YUV 4:4:4 format is the same as that in the RGB 8:8:8 format. Both have the same configuration in which one pixel is composed of 24 bits.

Image data as the YUV 4:2:2 format is composed of 32 bits per two pixels. That is, each pixel has the luminance component Y of eight bits. Every two pixels adjacent in a horizontal direction have the color-difference component U of eight bits and the color-difference component V of eight bits. In other words, each color-difference component is shared by two pixels. For natural image, image quality represented by the YUV 4:4:2 format is the same as that by the RGB 8:8:8, so that it is difficult to differentiate the two by human's eyes. However, 16 bits are enough per pixel.

Image data as the YUV 4:1:1 format is composed of 48 bits per four pixels. That is, each pixel has the luminance component Y of eight bits. Every four pixels adjacent in a horizontal direction have the color-difference component U of eight bits and the color-difference component V of eight bits. In other words, each color-difference component is shared by four pixels. The YUV 4:1:1 format is inferior to the YUV 4:2:2 format in image quality. However, the YUV 4:1:1 format can reduce data size smaller than that of the YUV 4:2:2 format.

The YUV 4:2:0 format differs in even and odd lines arranged in a vertical direction. In even lines, the image data as the YUV 4:2:0 format is composed of 32 bits per two pixels. That is, each pixel has the luminance component Y of eight bits. Every two pixels adjacent in the horizontal direction have the color-difference component U of eight bits and the color-difference component V of eight bits. In other words, each color-difference component is shared by two pixels. In odd lines, the image data as the YUV 4:2:0 format has only a luminance component Y of eight bits for each pixel and color-difference components of even line are used as the color-difference components U and V for each pixel. As a result, data size per screen of the YUV 4:2:0 format is equal to that of the YUV 4:1:1 format.

In the first comparative example, all the image data stored in the memory 21 is unified in the YUV format. This leads to an increase in circuit size of the display controller 11 and an in power consumption. Therefore, the RGB format is well-suited to three-dimensional image processing performed by a host or a graphic module. Image data as the RGB format in which image data is included in each pixel allows coordinate conversions or color conversions, etc., to be performed without any changes. Among the YUV formats, especially, the YUV 4:4:4 format that has image data in each pixel shows a disadvantage.

Additionally, graphic modules currently provided as an intellectual property (IP) core correspond only the RGB format. If the image data as the memory 21 is converted to the YUV format, the YUV/RGB format conversion part 31 is required.

In this way, image data as the RGB format supplied by the host, etc., definitely needs to be converted to the YUV format. In contrast, the YUV format needs to be converted to the RGB format when image data is supplied to the host, etc., from the display controller. Consequently, a conversion processing is required every input and output relative to the host, etc.

Alternatively, if all the image data stored in the memory 22 is unified in the RGB format as in the second comparative example, this leads to an increase of data size as compared with the YUV format as shown in FIG. 4, whereby the number of pixels is lessened that can be stored in the memory. In particular, image quality of the YUV 4:2:2. is the same level as that of the RGB 8:8:8. Thus, image data as the YUV 4:2:2 maintains higher image quality than that of other RGB formats, and less increase in capacity is needed.

In contrast, in the embodiment of the invention, image data as the YUV format and the RGB format can be mixedly stored in the memory 20. Thus, for example, image data as the YUV format from the camera I/F circuit 40 is not converted to the RGB format for writing in the memory 20. This makes it possible to increase efficiency in use of the memory 20. In addition, image data can be retained in the memory as a format suitable for the display driver to display. As compared with a case where all the image data stored in the memory 20 is unified in the YUV format, converting the YUV format to the RGB format is not required every time, even though in a case where the same image data is repeatedly output to the display driver from the memory 20. Further, for example, image data as the RGB format from the host I/F circuit 60 is not converted to the YUV format for writing in the memory 20. This allows the image data to be output to the host, etc., with ease of three-dimensional image processing, etc., whereby processability of image data stored in the memory 20 can be maintained.

If needed, the format conversion part 30 converts a format of image data stored in the memory 20 to write it in the memory 20. Then, the format conversion part 30 outputs the written image data.

In the embodiment of the invention, it is noted that data size between the image data as the YUV format and the image data as the RGB format keep a constant relationship before and after format conversion processing. From this point of view, the format conversion part 30 writes the converted image data as the memory 20 by the following manner.

The format conversion part 30 sets a write start address of converted image data as the memory 20 so that a memory region in the memory 20 is provided in which the image data before conversion is stored, while the converted image data is written so as to be overlapped. Then, while updating a write address based on the write start address, the converted image data is written in the memory region in the memory 20 specified by the write address. This allows an operation region in a memory required for format conversion processing of image data to be omitted or a memory capacity required for the operation region to be significantly reduced. As a result, a memory region in the memory can be utilized effectively, enabling the memory capacity to be reduced.

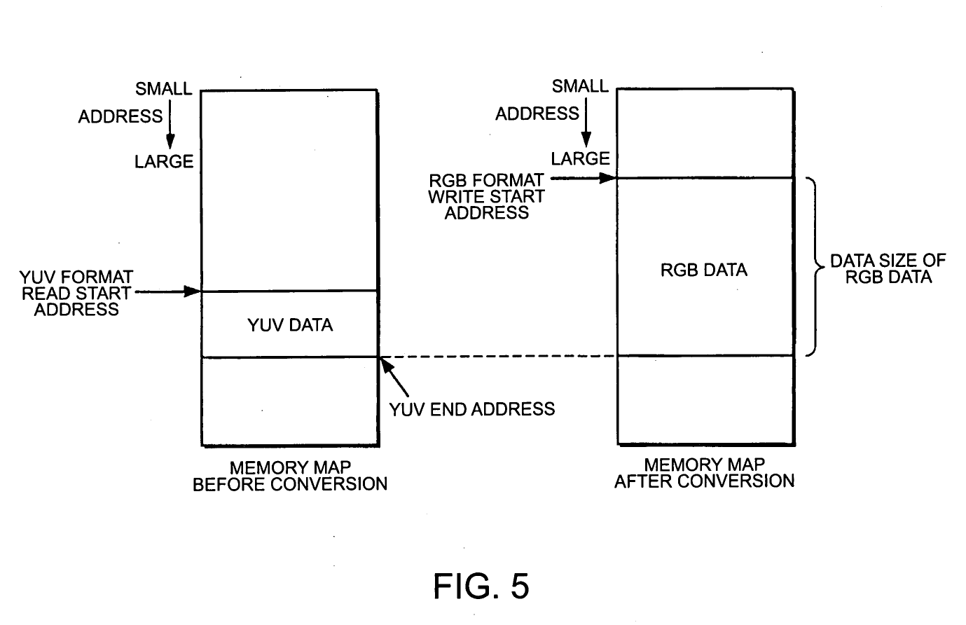

FIG. 5 is an explanatory diagram illustrating a setting method of the write start address in the memory 20 in a case where the YUV format is converted to the RGB format. Here, memory maps in the memory 20 before and after format conversion are schematically represented.

In this case, the data size of the converted image data as the RGB format is the same as that of the image data as the YUV format before conversion (in a case of the YUV 4:4:4 format) or more (in a case of the YUV 4:2:2 format, the YUV 4:1:1 format, and the YUV 4:2:0 format). Therefore, the write start address of the image data as the RGB format in the memory 20 can be obtained by a back calculation of an end address of the image data as the YUV format. For example, it can be set by the following manner.

If a memory region of the image data before conversion in the memory 20 is specified with a (read) start address and an (read) end address, i.e., the image data before conversion is continuously stored in a memory region designated by the start address and the end address in the memory 20, a write start address of the RGB format can be smaller than the address obtained by subtracting an address corresponding to a data size of the converted image data from the end address of the YUV format as the following relationship. Write start address of the RGB format <end address of the YUV format—the RGB format data size.

This allows the converted image data as the RGB format to write back in the memory region of the image data as the YUV format before conversion, thereby enabling a memory capacity required for the operation region of format conversion processing to be reduced correspondingly.

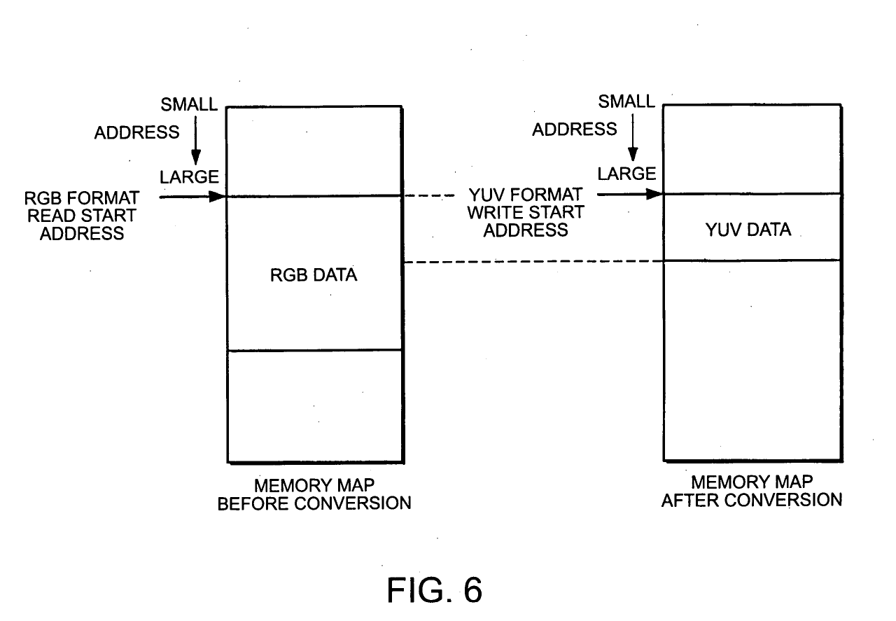

FIG. 6 is an explanatory diagram illustrating a setting method of the write start address in the memory 20 in a case where the RGB format is converted to the YUV format. Here, memory maps in the memory 20 before and after format conversion are schematically represented.

In this case, the data size of the converted image data as the YUV format is the same as that of the image data as the RGB before conversion (in a case of the YUV 4:4:4 format) or below (in a case of the YUV 4:2:2 format, the YUV 4:1:1 format, and the YUV 4:2:0 format). Therefore, the write start address of the image data as the YUV format in the memory 20 can be set as an address and below, the address being the start address of the image data as the RGB format.

If a memory region of the image data before conversion in the memory 20 is specified by a (read) start address and an (read) end address, i.e., the image data before conversion is continuously stored in a memory region designated by the start address and the end address in the memory 20, a write start address of the YUV format can be the (read) start address of the RGB format or smaller than the start address as the following relationship. Write start address of the YUV format ≦(read) start address of the RGB format.

This allows the converted image data as the YUV format to write back in the memory region of the image data as the RGB format before conversion, thereby enabling a memory capacity required for the operation region of format conversion processing to be reduced correspondingly.

Next, detailed hardware configuration examples of the display controller according to the embodiment of the invention will be described.

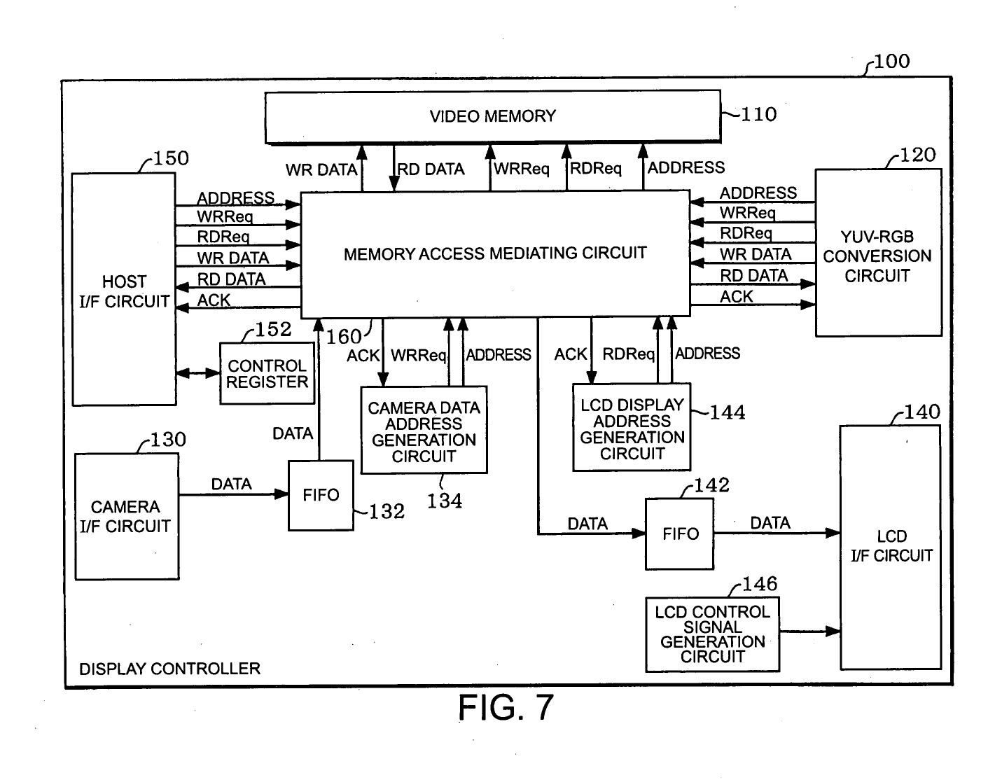

FIG. 7 is a block diagram illustrating a hardware configuration example of the display controller according to the embodiment of the invention.

In a display controller 100, functions of the memory 20 in FIG. 1 are embodied by a video memory 110. Functions of the format conversion part 30 in FIG. 1 are embodied by a YUV-RGB conversion circuit 120. In addition, functions of the camera I/F circuit 40 in FIG. 1 are embodied by a camera I/F circuit 130, functions of the LCD I/F circuit 50 in FIG. 1 are embodied by a LCD I/F circuit 140, and functions of the host I/F circuit 60 in FIG. 1 are embodied by a host I/F circuit 150.

Also, functions of controller 70 in FIG. 1 are embodied by a First-In-First-Out (FIFO) 132, a camera data address generation circuit 134, a FIFO 142, a LCD display address generation circuit 144, a LCD control signal generation circuit 146, a control register 152, and a memory access mediating circuit 160.

The FIFO 132 functions as a receiving buffer for the image data as the YUV format that is input to the camera I/F circuit 130, and outputs the image data loaded in the FIFO 132 sequentially to the memory access mediating circuit 160. The camera data address generation circuit 134 generates a write request signal WRReq and a write address. The WRReq is a signal for writing image data to the video memory 110, the image data being output to the memory access mediating circuit 160 from the FIFO 132.

The FIFO 142 functions as a transmitting buffer for the image data as the RGB format that is output from the memory access mediating circuit 160, and outputs the image data loaded in the FIFO 142 sequentially to the LCD I/F circuit 140. The LCD display address generation circuit 144 generates a read request signal RDReq and a read address. The RDReq is a signal for reading data from the video memory 110 to output it to the FIFO 142. The LCD control signal generation circuit 146 generates a LCD control signal that is a display sync signal such as a vertical sync signal, a horizontal sync signal and a dot clock, etc., that are supplied to the display driver with image data output from the FIFO 142.

In the control register 152, control data for controlling the display controller 100 is set. Each part of the display controller 100 is controlled based on the control data in the control register 152.

The memory access mediating circuit 160 mediates accesses to the video memory 110 from the YUV-RGB conversion circuit 120, the camera I/F circuit 130, the LCD I/F circuit 140, and the host I/F circuit 150. The memory access mediating circuit 160 mediates a plurality of write request signals WRReq and a plurality of read request signals RDReq. To a circuit to which an access is permitted based on a mediation result, completion of the access is notified with an acknowledge signal ACK that corresponds to the request signal.

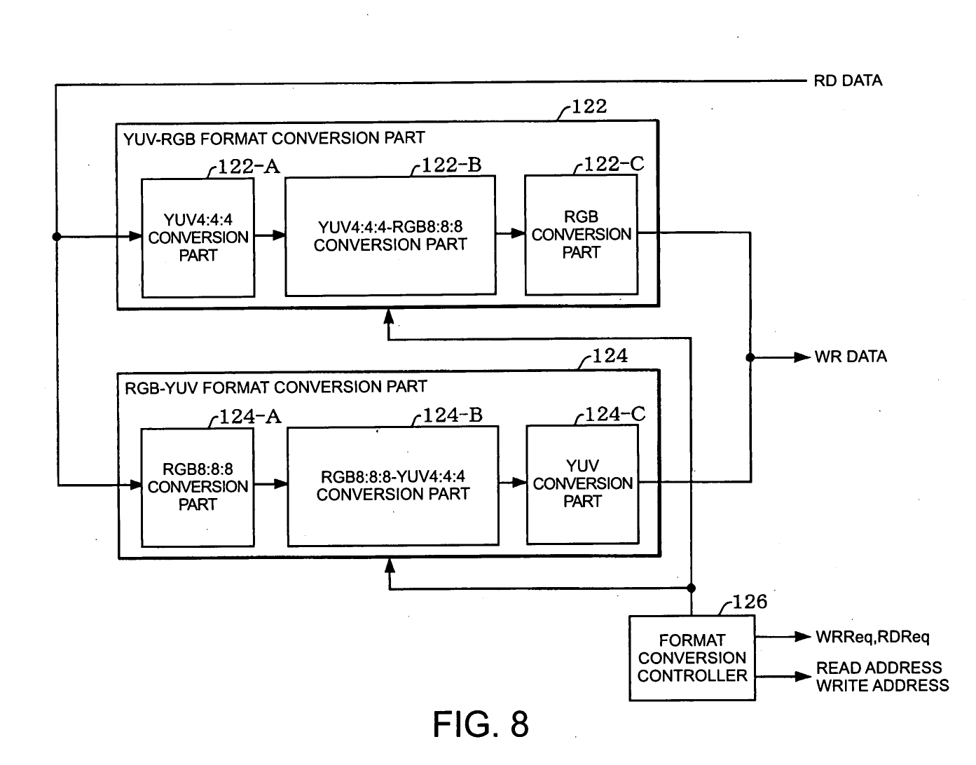

FIG. 8 is a block diagram illustrating a configuration example of the YUV-RGB conversion circuit 120 in FIG. 7.

The YUV-RGB conversion circuit 120 includes a YUV-RGB format conversion part 122, a RGB-YUV format conversion part 124, and a format conversion controller 126. In the YUV-RGB format conversion part 122, the image data as the YUV format that is read data (RD data) from the video memory 110 is converted to the image data as the RGB format. In the RGB-YUV format conversion part 124, the image data as the RGB format that is read data (RD data) from the video memory 110 is converted to the image data as the YUV format.

The format conversion controller 126 controls the YUV-RGB format conversion part 122 and the RGB-YUV format conversion part 124. More specifically, the format conversion controller 126 outputs write data (WR data) to the video memory 110 by operating either the YUV-RGB format conversion part 122 or the RGB-YUV format conversion part 124.

In the YUV-RGB format conversion part 122, image data is temporarily converted to the YUV 4:4:4 format, in turn converted to the RGB 8:8:8 format, subsequently, converted to the image data in other RGB formats. Thus, the YUV-RGB format conversion part 122 includes a YUV 4:4:4 conversion part 122-A, a YUV 4:4:4-RGB 8:8:8 conversion part 122-B, and a RGB conversion part 122-C. In the YUV 4:4:4 conversion part 122-A, read data in any of YUV 4:4:4 format, YUV 4:2:2 format, YUV 4:1:1 format, and YUV 4:2:0 format is converted to the image data format of YUV 4:4:4 . If data is converted to the YUV 4:4:4 format, read data in the YUV 4:4:4 format is output without any changes. The above-mentioned configuration and operation of the YUV 4:4:4 conversion part 122-A are well known. Thus, explanations are omitted.

In the YUV 4:4:4-RGB 8:8:8 conversion part 122-B, the image data as the YUV 4:4:4 format converted by the YUV 4:4:4 conversion part 122-A is converted to the image data as the RGB 8:8:8 format.

In the RGB conversion part 122-C, the image data as the RGB 8:8:8 format is converted to the image data as any of RGB 3:3:2 format, RGB.5:6:5 format, and RGB 8:8:8 format. If data is converted to the RGB 8:8:8 format, the input image data as the RGB 8:8:8 format is output without any changes. Such configuration and operation of the. RGB conversion part 122-C are well known. Thus, explanations are omitted.

In the RGB-YUV format conversion part 124, image data is temporarily converted to the RGB 8:8:8 format, in turn converted to the YUV 4:4:4 format, subsequently, converted to the image data in other YUV formats. Thus, the RGB-YUV format conversion part 124 includes a RGB 8:8:8 conversion part 124-A, a RGB 8:8:8-YUV 4:4:4 conversion part 124-B, and a YUV conversion part 124-C. In the RGB 8:8:8 conversion part 124-A, read data in any of the RGB 3:3:2 format, the RGB 5:6:5 format, and the RGB 8:8:8 format is converted to the image data of the RGB 8:8:8 format. If data is converted to the RGB 8:8:8 format, read data in the RGB 8:8:8 format is output without any changes. Such configuration and operation of the RGB 8:8:8 conversion part 124-A are well known. Thus, explanations are omitted.

In the RGB 8:8:8-YUV 4:4:4 conversion part 124-B, the image data as the RGB 8:8:8 format converted by the RGB 8:8:8 conversion part 124-A is converted to the image data as the YUV 4:4:4 format.

In the YUV conversion part 124-C, the image data as the YUV 4:4:4 format is converted to the image data as any of the YUV 4:4:4 format, the YUV 4:2:2 format, and the YUV 4:2:0 format. If data is converted to the YUV 4:4:4 format, the input image data as the YUV 4:4:4 format is output without any changes. Such configuration and operation of the YUV conversion part 124-C are well known. Thus, explanations are omitted.

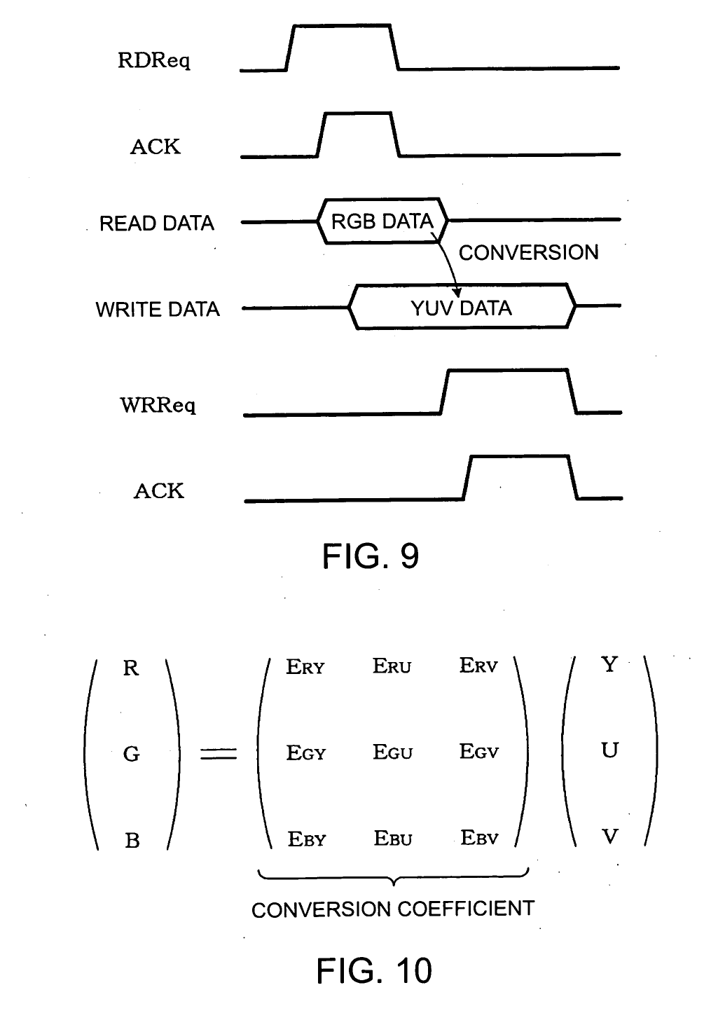

FIG. 9 is a timing chart illustrating an operational example of the YUV-RGB conversion circuit 120 in FIG. 8.

In FIG. 9 shows an example of operational timing in a case where the image data as the RGB format (RGB data) is read from the video memory as read data so as to be converted to the image data as the YUV format (YUV data) for outputting the image data as write data. In this case, the format conversion controller 126 in FIG. 8 generates a read request signal RDReq, a read address, a write request signal WRReq, and a write address that are output to the video memory 110 via the memory access mediating circuit 160. The format conversion controller 126, while updating a read address based on a read start address designated in the control register 152, outputs the read address together with the read request signal RDReq. The completion of the access started by the read request is notified by the acknowledge signal ACK.

In addition, the format conversion controller 126, while updating a write address based on a write start address designated in the control register 152, outputs the write address together with the write request signal WRReq. The completion of the access started by the write request is notified by the acknowledge signal ACK.

Next, a hardware configuration example of the YUV 4:4:4-RGB 8:8:8 conversion part 122-B in FIG. 8 will be described.

The YUV 4:4:4-RGB 8:8:8 conversion part 122-B performs a conversion processing in accordance with the transformation determinant shown in FIG. 10. If a conversion coefficient is used as a variable, an inner product operation circuit is required for hardware that puts the conversion processing in accordance with the transformation determinant shown in FIG. 10 into practice, thereby resulting in an increase of circuit size. In the embodiment, the conversion coefficient is a fixed value, and a multiplication circuit is achieved by shift adding. As a result, the circuit size is reduced.

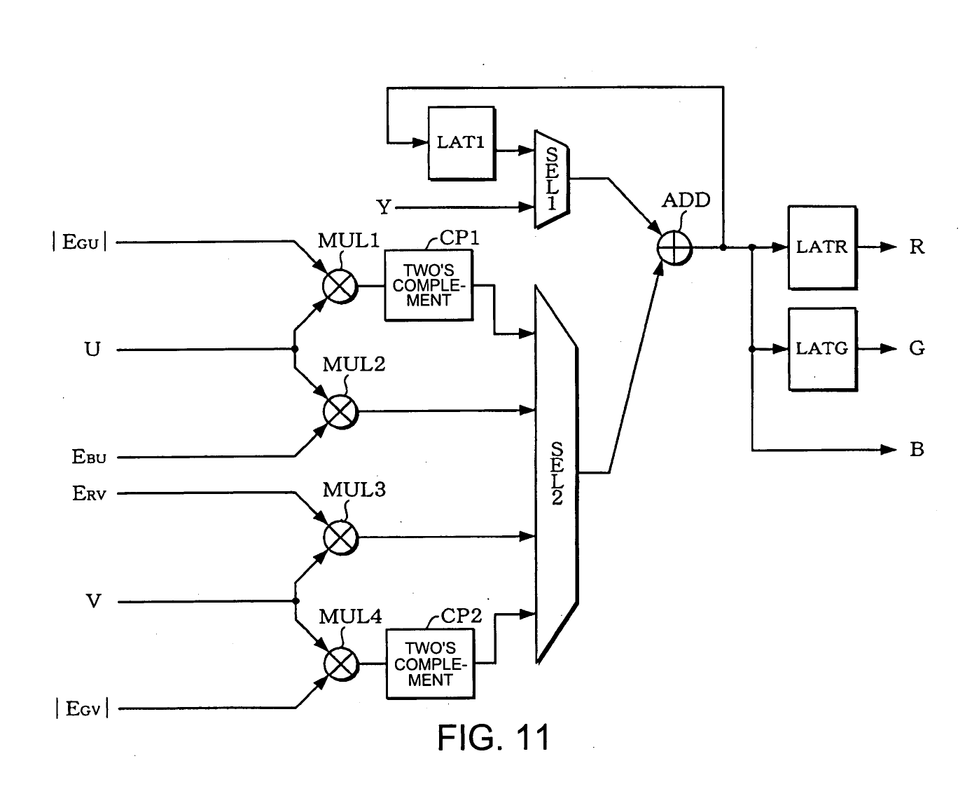

FIG. 11 is a block diagram illustrating a hardware configuration example of the YUV 4:4:4-RGB 8:8:8 conversion part 122-B.

FIG. 11 shows a hardware configuration example in which conversion coefficients shown in FIG. 10 are E_{RY}=1.000, E_{RU}=0.000, E_{RV}=1.402, E_{GY}=1.000, E_{GU}=−0.344, E_{GV}=−0.714, E_{BY}=1.000, E_{BU}=1.772, and E_{BV}=0.000. In this case, since all the coefficients of luminance component Y is one, no multiplication circuit can be needed. Also, since coefficients E_{RU} and E_{BV} are zero, no multiplication circuit can be needed. In addition, since coefficients EGU and EGV are negative values, two's complement circuits are provided.

A selector SEL1 selectively outputs either the output of the luminance component Y or the output of a latch LAT1. The LAT1 latches the output of an adder ADD.

A selector SEL2 selectively outputs any of E_{GU}×U, E_{BU}×U, E_{RV}×V, and E_{GV}×V. The value of E_{GU}×U is obtained by a multiplier MULL and a two's complement circuit CP1. The value of E_{BU}×U is obtained by a multiplier MUL2. The value of E_{RV}×U is obtained by a multiplier MUL3. The value of E_{GV}×V is obtained by a multiplier MUL4 and a two's complement circuit CP2.

The adder ADD adds the output of the selector SEL1 and the output of the selector SEL2. The output of the adder ADD is retained in the latches LAT1, LATR, and LATG. The output of the latch LATR serves as the data of component R of the image data as the RGB format. The output of the latch LATG serves as the data of component G of the image data as the RGB format.

Each part of the YUV 4:4:4-RGB 8:8:8 conversion part 122-B is controlled by a control signal from the format conversion controller 126.

The multipliers MUL 1 through MUL4 are achieved by a shift adding circuit.

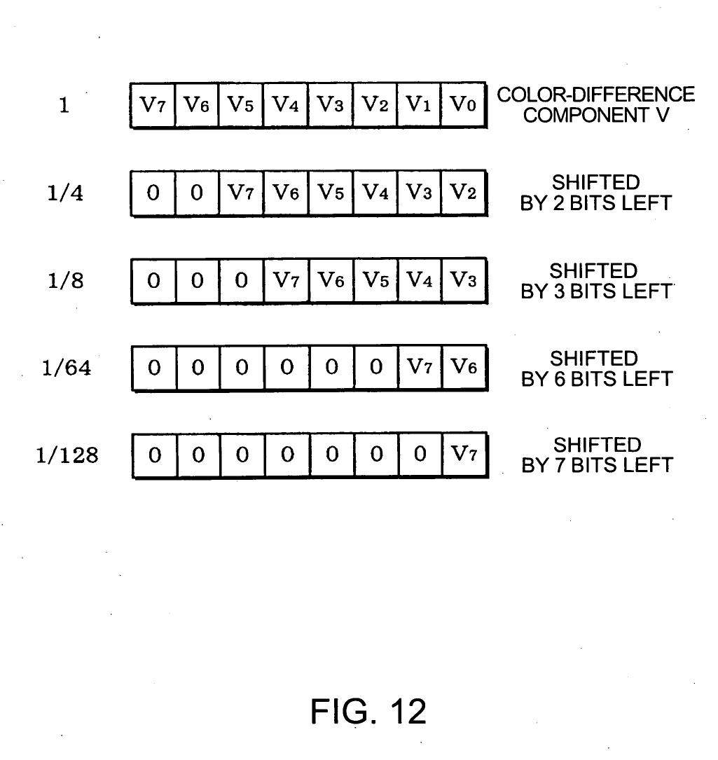

FIG. 12 is an explanatory diagram illustrating operations of the shift adding circuit.

In the view, an example of shift adding operations of the multiplier MUL3 is shown. As shown in FIG. 11, the multiplier MUL3 obtains the product of the color-difference component V and the coefficient E_{RV} (=1.402).

The value of the coefficient ERV, 1.402, can be approximated the following formula.
1.402=1+¼+⅛+ 1/64+ 1/128

Here, ¼ is obtained by shifting the color-difference component V by 2 bits left; ⅛ is obtained by shifting the color-difference component V by 3 bits left; 1/64 is obtained by shifting the color-difference component V by 6 bits left; and 1/128 is obtained by shifting the color-difference component V by 7 bits left.

Accordingly, if each bit of the color-difference component V is represented as V7, V6, V5, . . . , V0, they are represented as shown in FIG. 12. Consequently, the result of V×1.402 can be obtained by adding the color-difference component V and each shifting result of the color-difference component V.

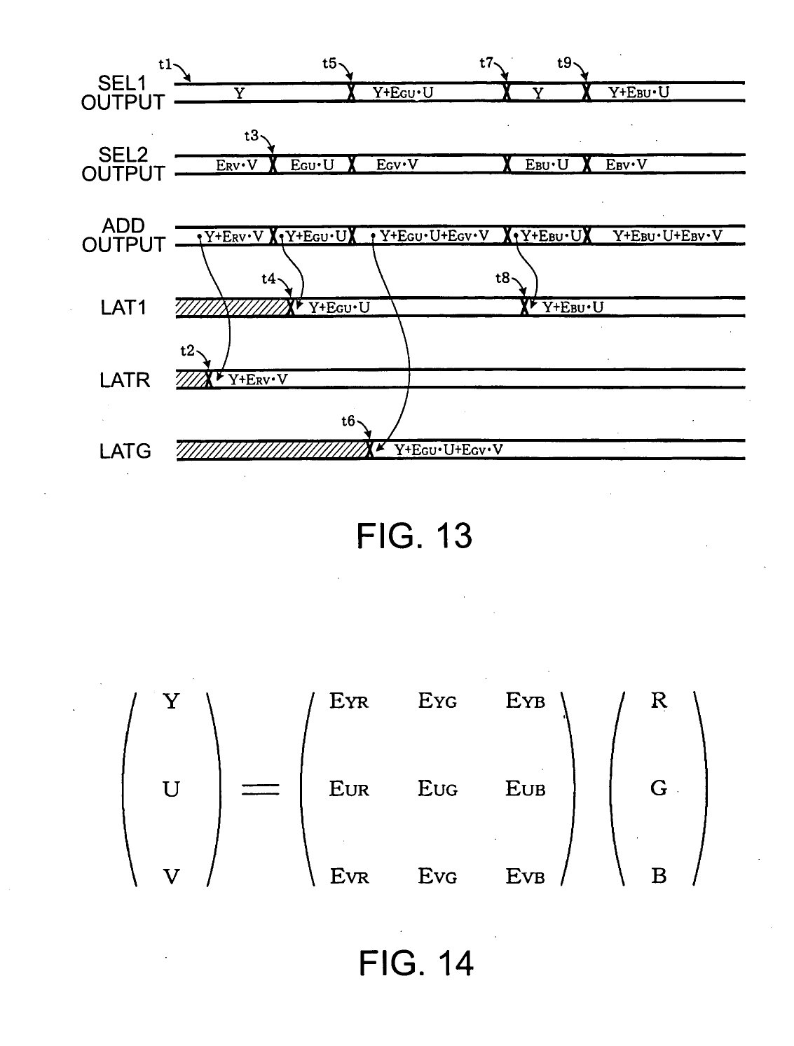

FIG. 13 is a timing diagram illustrating an operational example of the YUV 4:4:4-RGB 8:8:8 conversion part 122-B in FIG. 11.

At a time t1, the SELL selects the luminance component Y, while the selector SEL2 selects “E_{RV}×V.” Thus, the adder ADD outputs the value of “Y+E_{RV}×V”, which is loaded to the latch LATR to be retained as the data of component R at a time t2.

At a time t3, the selector SEL2 switches its output to “E_{GU}×U”, and the adder ADD outputs the value of “Y+E_{GU}×U”, which is loaded to the latch LAT1 at a time t4. At a time t5, the selector SEL1 switches its output to the output of the latch LAT1, while the selector SEL2 switches its output to “E_{GV}×V.” Thus, the adder ADD outputs the value of “Y+E_{GU}×U+E_{GV}×V”, which is loaded to the latch LATG to be retained as the data of component G at a time t6.

At a time t7, the selector SELL switches its output to the luminance component Y, while the selector SEL2 switches its output to “E_{BU}×U.” The adder ADD outputs the value of “Y+E_{BU}×U”, which is loaded to the latch LAT1 at a time t8. At a time t9, the selector SELL switches its output to the output of the latch LAT1, while the selector SEL2 switches its output to “E_{BV}×V.” Thus, the adder ADD outputs the value of “Y+E_{BU}×U+E_{BV}×V”, which is output as the data of component B.

The RGB 8:8:8-YUV 4:4:4 conversion part 124-B performs a conversion processing in accordance with the transformation determinant shown in FIG. 14. In this case, in the RGB 8:8:8-YUV 4:4:4 conversion part 124-B, a conversion coefficient is set to be a fixed value, and a multiplier circuit can be achieved by shift adding, likewise the above-mentioned YUV 4:4:4-RGB 8:8:8 conversion part 122-B. The RGB 8:8:8-YUV 4:4:4 conversion part 124-B can also be configured likewise the YUV 4:4:4-RGB 8:8:8 conversion part 122-B, the explanation of configuration examples of the RGB 8:8:8-YUV 4:4:4 conversion part 124-B is omitted.

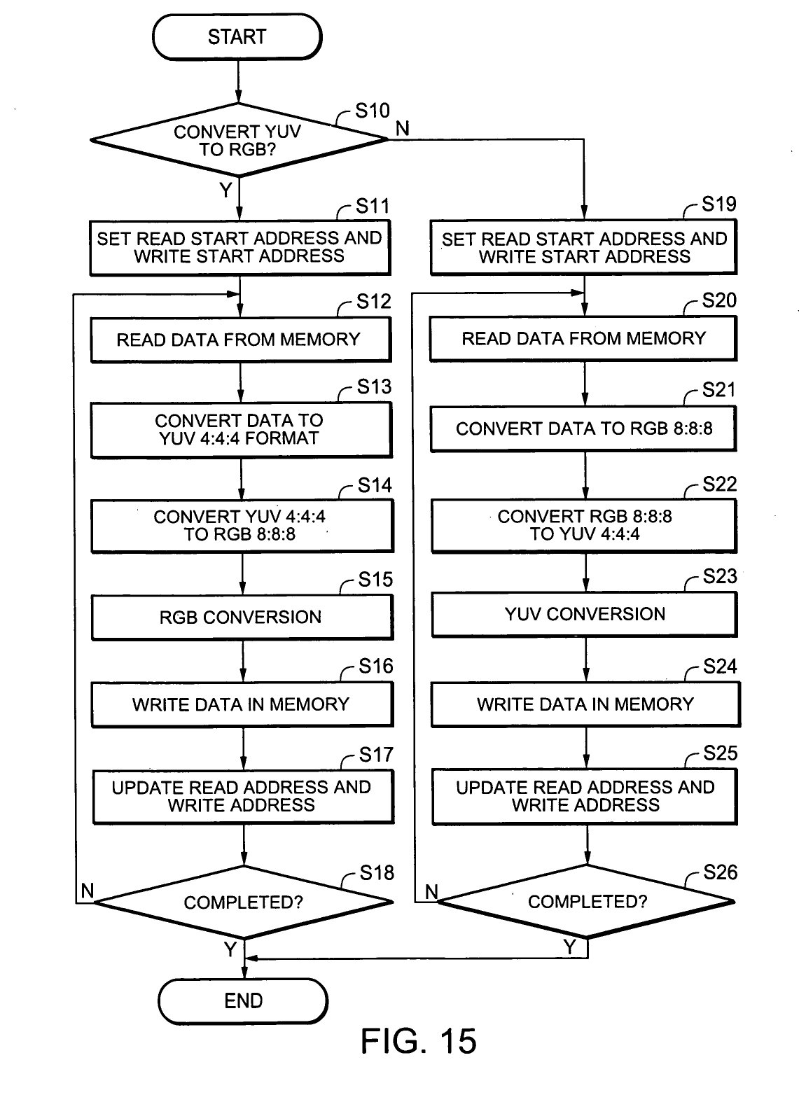

FIG. 15 is a flow chart illustrating a processing example of the YUV-RGB conversion circuit 120.

For example, the format conversion controller 126 performs controls for achieving the following processes.

In a case where the YUV format is converted to the RGB format (step S10: Y), a read start address of the image data before conversion that is stored in the video memory 110, and a write start address of the converted data to be stored in the video memory 110 are firstly set to a temporary register (not shown), etc., (step S11).

Then, the image data as the YUV format before conversion is read from the video memory 110 using a read address based on the read start address until the number of bytes is reached a given value (step S12).

Then, the image data is converted to the YUV 4:4:4 format (step S13). Next, the image data converted in the YUV 4:4:4 format is converted to the RGB 8:8:8 format as shown in FIG. 11 (step S14).

Next, the converted image data as the RGB 8:8:8 format is converted to any of the RGB 3:3:2 format, the RGB 5:6:6 format, and the RGB 8:8:8 format (step S15). Then, the converted image data is written in the video memory 110 using a write address based on the write start address (step S16).

Subsequently, the read address and write address that are stored in the temporary register, etc., are revised (step S17). If the step is not ended (step S18: N), the step returns to step S12. If the step is ended in step S18 (step S18: Y), the sequence of the processing is completed (end).

In a case where the RGB format is converted to the YUV format in step S10 (step S10: N), a read start address of the image data before conversion that is stored in the video memory 110, and a write start address of the converted data to be stored in the video memory 110 are set to a temporary register (not shown), etc., (step S19).

Then, the image data as the RGB format before conversion is read from the video memory 110 using a read address based on the read start address until the number of bytes is reached a given value (step S20).

Then, the image data is converted to the RGB 8:8:8 format (step S21). Next, the image data converted in the RGB 8:8:8 format is converted to the YUV 4:4:4 format (step S22).

Next, the converted image data as the YUV 4:4:4 format is converted to any of the YUV 4:4:4 format, the YUV 4:2:2 format, the YUV 4:1:1 format, and the YUV 4:2:0 format (step S23). Then, the converted image data is written in the video memory 110 using a write address based on the write start address (step S24).

Subsequently, the read address and write address that are stored in the temporary register, etc., are revised (step S25). If the step is not ended (step S26: N), the step returns to step S20. If the step is ended in step S26 (step S26: Y), the sequence of the processing is completed (end).

The display controller 100 having the above-mentioned configurations is driven by a host (not shown) to start a format conversion. The host includes a central processing unit (CPU) and a memory, in which a program is stored that achieves the following processes. The CPU reads the program from the memory to achieve the following processes.

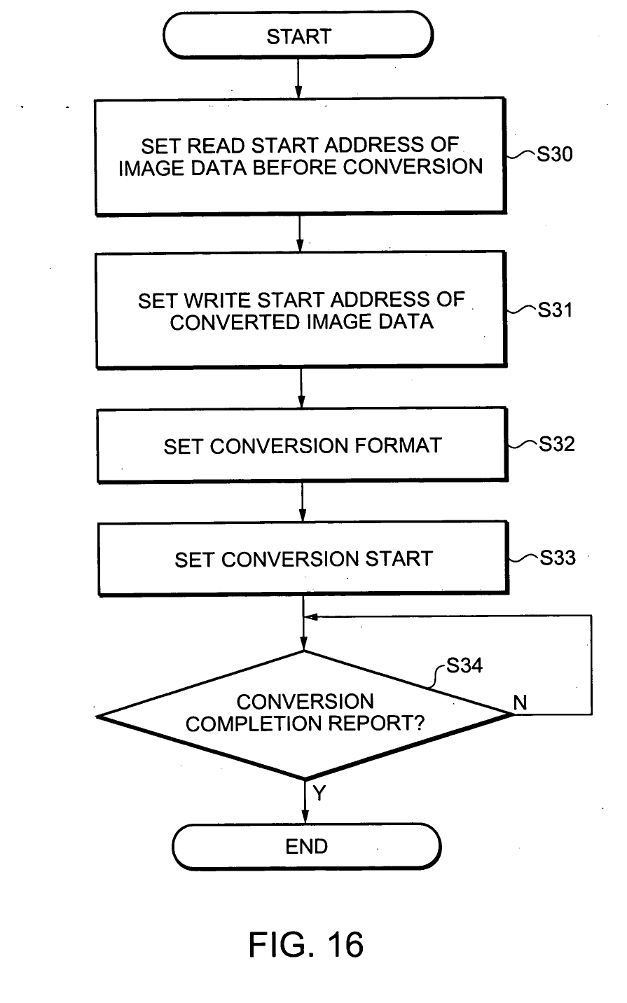

FIG. 16 is a flow chart illustrating a processing example of the host.

First, the host sets a read start address of the image data before conversion to the display controller 100 (step S30). The host sets the read start address to the control register 152 via the host I/F circuit 150 of the display controller 100. The set read address is used in the YUV-RGB conversion circuit 120 as described above.

Then, the host sets a write start address of the converted image data to the display controller 100 (step S31). The host sets the write start address to the control register 152 via the host I/F circuit 150 of the display controller 100. The set write address is used in the YUV-RGB conversion circuit 120 as described above.

Here, the host generates the write start address in accordance with a type of format conversion processing as described referring to FIG. 5 or FIG. 6. In a case where the display controller 100 includes a configuration for generating the write start address as described in FIG. 5 or FIG. 6, step S31 may be omitted, or the data size of the RGB format after conversion may be set in step S31.

Subsequently to step S31, the host performs a format conversion setting (step S32). The setting is for designating either the processing of converting the YUV format to the RGB format, or the processing of converting the RGB format to the YUV format. The setting is set to the control register 152 via the host I/F circuit 150 of the display controller 100 by the host.

Then, the host sets a conversion processing start setting to the display controller 100 (step S33). For example, setting of the control register 152 by the host triggers the display controller 100 to start a format conversion processing that corresponds to settings in steps S10 through S12. In this case, the format conversion controller 126 controls the YUV-RGB conversion circuit 120.

The host monitors a conversion processing end report from the display controller 100 (step S34: N). Upon receiving the report (step S34: Y), the sequence of the processing is completed (end). In the display controller 100, upon starting a format conversion processing in step S33, a conversion processing end report can be performed by an interruption to the host as the end of the format conversion processing.

The present invention is not limited to the configurations in the above-mentioned embodiment.

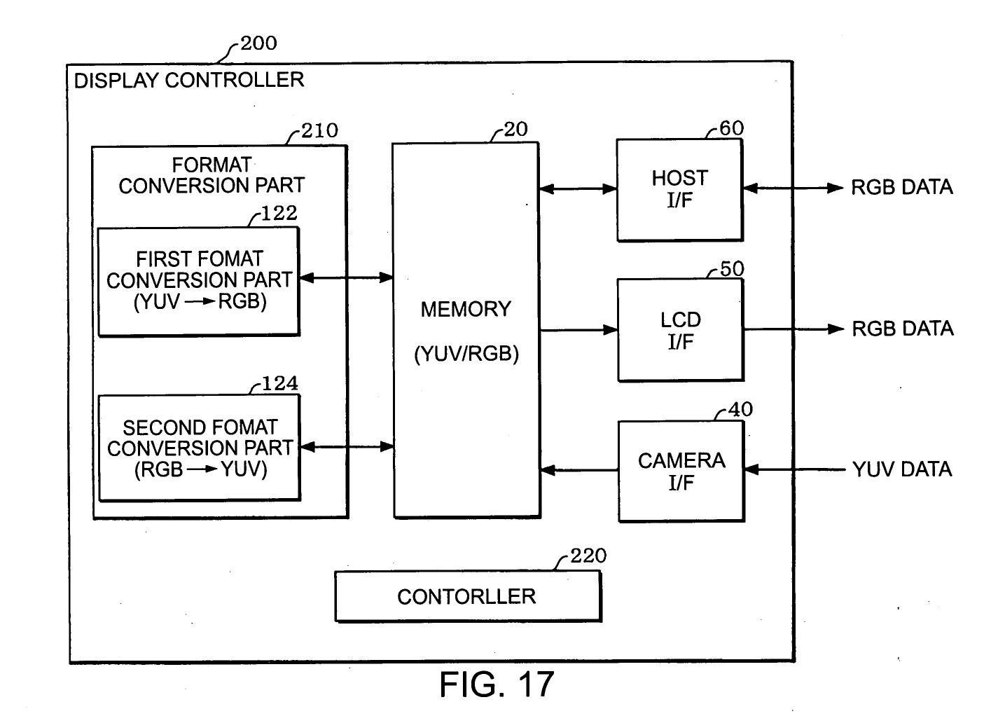

FIG. 17 is a block diagram illustrating a rough configuration of a display controller in the first modification example of the embodiment of the invention. However, the same parts of those of the display controller 10 shown in FIG. 1 are given the same numerals with explanation omitted as appropriate.

In the first modification example, the format conversion part 210 includes the first and second format conversion parts each of which performs a format conversion processing and a write processing of the converted image data to the memory 20 individually. The first format conversion part reads the image data as the YUV format from the memory 20 so as to convert the image data to the RGB format, in turn, writes the converted image data as the RGB format to the memory 20. Alternatively, the second format conversion part reads the image data as the RGB format from the memory 20 so as to convert the image data to the YUV format, in turn, writes the converted image data as the YUV format to the memory 20.

Such the first format conversion part is achieved by the YUV-RGB format conversion part 122 shown in FIG. 8. Alternatively, the second format conversion part is achieved by the RGB-YUV format conversion part 124 shown in FIG. 8. The controller 220 individually controls the operations (format conversion processing and access to the memory 20) of such the first and second format conversion parts.

In this case, a plurality of format conversion processes can be performed simultaneously as follows: if the first format conversion part converts the image data as the YUV format to the image data as the RGB format, the second format conversion part can convert another image data as the RGB format to the image data as the YUV format.

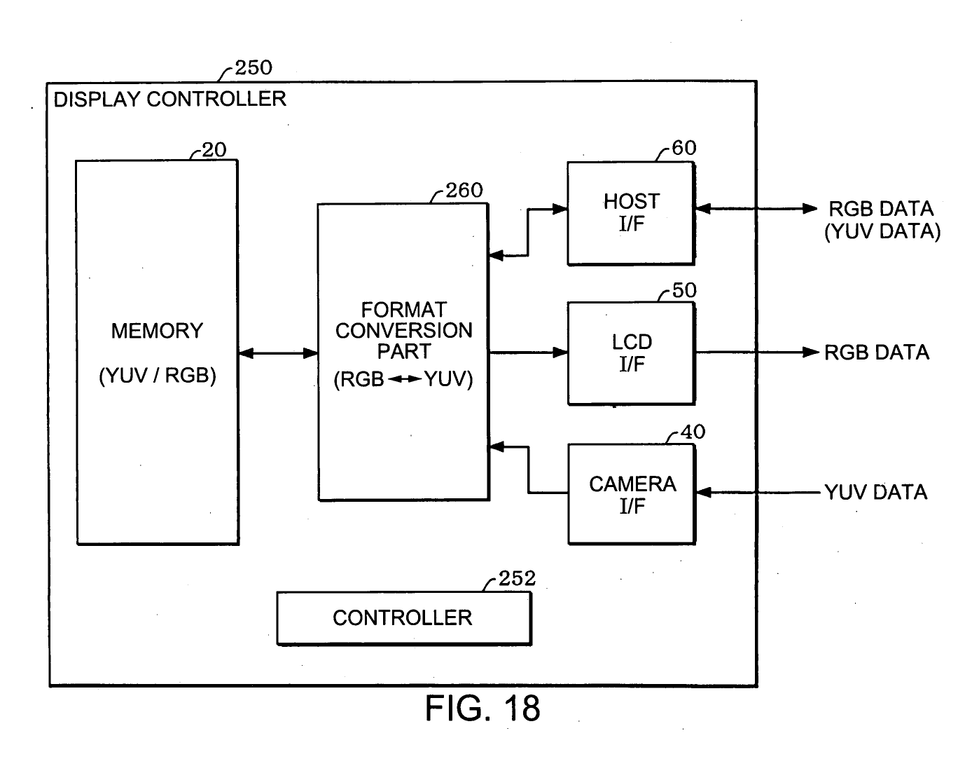

FIG. 18 is a block diagram illustrating a rough configuration of a display controller in the second modification example of the embodiment of the invention. However, the same parts of those of the display controller 10 shown in FIG. 1 are given the same numerals with explanation omitted as appropriate.

In the second modification example, a format conversion part 260 is provided between the memory 20 and the camera I/F circuit 40, the LCD I/F circuit 50, and the host I/F circuit 60. The operations of the format conversion part 260 are the same as those of the format conversion part 30. In the operations, the format conversion part 260 accesses the memory 20 so as to perform a format conversion to write back the converted image data as the memory 20.

In this case, even though in a case where a format of the image data that is input and output via a I/F circuit is different from a format of the image data to be stored in the memory 20, the data after a format conversion processing can be transmitted to and received from the I/F circuit while writing the data in the memory 20. As a result, processing time may be reduced.

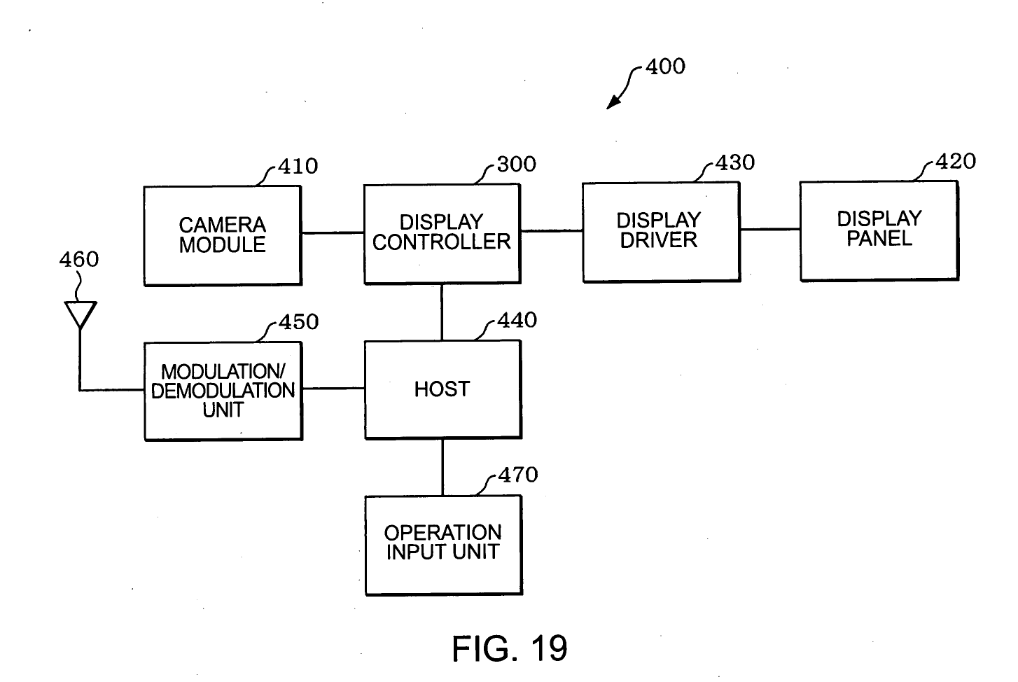

FIG. 19 is a block diagram illustrating a configuration example of electronic apparatuses to which the display controller of the embodiment of the invention or their modification examples is applied. Here, a block diagram of a configuration example of a cellular phone as one of the electronic apparatuses is shown.

A cellular phone 400 includes a camera module 410. The camera module 410 has a CCD camera to supply the data of images captured by the CCD camera to a display controller 300 in YUV format.

The cellular phone 400 includes a display panel 420. A liquid crystal display panel can be used as the display panel 420. In this case, the display panel 420 is driven by a display driver 430. The display panel 420 includes a plurality of scanning lines, a plurality of data lines and a plurality of pixels. The display driver 430 has the function of a scanning driver for selecting scanning lines by the unit of one or plural scanning lines, while has the function of data driver for supplying a voltage corresponding to image data to the plurality of data lines.

The display controller 300 is coupled to the display driver 430 and supplies image data in RGB format to the display driver 430.

A host 440 is coupled to the display controller 300. The host 440 controls the display controller 300. Also, the host 440 can demodulate image data received via an antenna 460 at a modulation/demodulation unit 450, and then can supply the image data to the display controller 300. The display controller 300 displays images on the display panel 420 by the display driver 430 based on the image data.

The host 440 can modulate the image data generated by the camera module 410 at the modulation/demodulation unit 450, and then can indicate a transmission to another communication apparatus via the antenna 460.

The host 440 performs, based on operational information from an operation input unit 470, transmitting/receiving of image data, processing of format conversion, imaging at the camera module 410, and the displaying processing of the display panel.

The present invention is not limited to the example of FIG. 19 in which a liquid crystal display panel is used as the display panel 420. The display panel 420 may be an electro luminescent display or a plasma display device, and can be applied to a display controller supplying image data to a display driver for driving the display.

It should be noted that the invention is not limited to the above-mentioned embodiment, and can be modified within the scope of the invention.

As for the dependent claims of the invention, it is possible to omit part of the elements claimed in the claims on which they depend. Moreover, the feature claimed in one of the independent claims of the invention may be depend on another independent claim.

1. A display controller that supplies image data to a display driver driving a display panel, comprising:
a memory in which image data in a YUV format and image data in a RGB format are mixedly stored;
a format conversion part that performs a conversion processing between the image data in the YUV format and the image data in the RGB format;
an image data input interface to which the image data in the YUV format is input, the image data being supplied to the memory; and
a display driver interface that outputs the image data in the RGB format read from the memory to the display driver; wherein
the format conversion part reads the image data in the YUV format from the memory to convert the image data to the RGB format, writing the converted image data in the RGB format in the memory, and the image data in the RGB format written in the memory by the format conversion part is supplied to the display driver.

2. The display controller according to claim 1, wherein
the format conversion part sets a first write start address of the converted image data in the RGB format in the memory so that a memory region in the memory is provided in which the image data in the YUV format before conversion is stored, while the converted image data in the RGB format is written so as to be overlapped, and, while updating a write address based on the first write start address, writes the image data in the RGB format in the memory region in the memory specified by the write address.

3. The display controller according to claim 2, wherein
in a case where a memory region of the image data in the YUV format before conversion is designated by a first start address and a first end address, the first write start address is smaller than an address obtained by subtracting an address corresponding to a data size of the converted image data in the RGB format from the first end address.

4. The display controller according to claim 1, further comprising a host interface to which at least one of the image data in the YUV format and the image data in the RGB format is input from the host so as to supply the image data to the memory, while by which at least one of the image data in the YUV format and the image data in the RGB format that are read from the memory is output to the host, wherein the format conversion part reads the image data in the RGB format to convert the image data to the YUV format, writing the converted image data in the YUV format in the memory, and the image data in the YUV format written in the memory by the format conversion part is output.

5. The display controller according to claim 4, wherein
the format conversion part sets a second write start address of the converted image data in the YUV format in the memory so that a memory region in the memory is provided in which the image data in the RGB format before conversion is stored, while the converted image data in the YUV format is written so as to be overlapped, and, while updating a write address based on the second write start address, writes the image data in the YUV format in the memory region in the memory specified by the write address.

6. The display controller according to claim 5, wherein
in a case where a memory region of the image data in the RGB format before conversion is designated by a second start address and a second end address in the memory, the second write start address is at least one of the second start address and smaller than the second start address.

7. The display controller according to claim 4, wherein
the format conversion part includes a first and a second format conversion parts each of which performs a format conversion processing and a write processing of the converted image data in the memory individually, wherein the first format conversion part reads the image data in the YUV format from the memory to convert the image data to the RGB format, writing the converted image data in the RGB format in the memory, while the second format conversion part reads the image data in the RGB format from the memory to convert the image data to the YUV format, writing the converted image data in the YUV format in the memory.

8. An electronic apparatus comprising:
a display panel;
the display controller according to claim 1; and
a display driver driving the display panel based on image data supplied by the display controller.

9. The electronic apparatus according to claim 8, further comprising a host that inputs and outputs at least one of the image data in the RGB format and the YUV format relative to the display controller.

10. A method for supplying image data to a display driver driving a display panel, comprising:
storing image data in a YUV format and image data in a RGB format mixedly in a memory;
reading the image data in the YUV format from the memory so as to convert the image data to the RGB format;
writing the converted image data in the RGB format in the memory; and
supplying the image data in the RGB format written in the memory to the display driver.

11. The method supplying image data according to claim 10, further comprising:
reading the image data in the RGB format from the memory so as to convert the image data to the YUV format;
writing the converted image data in the YUV format in the memory; and
supplying the image data in the YUV format written in the memory to a host.
